(19) United States
(12) Patent Application Publication
(10) Pub. No.: US 2020/0369307 A1
(43) Pub. Date: Nov. 26, 2020

(54) Wheeled Pulk and Associated Systems

(71) Applicant: Tribal Outdoor Gear Ltd., Canmore (CA)

(72) Inventors: Anthony Robert Dopf, Bragg Creek (CA); Murray John Pow, Canmore (CA); Brent Lawrence McConnell, Calgary (CA)

(21) Appl. No.: 16/882,300

(22) Filed: May 22, 2020

Related U.S. Application Data
(60) Provisional application No. 62/852,096, filed on May 23, 2019.

(51) Int. Cl. B62B 1/24; B62B 1/20; B62B 5/06

(52) U.S. Cl. CPC B62B 1/24; B62B 5/068; B62B 1/20

(57) ABSTRACT

Described herein is a wheeled pulk and related systems. The wheeled pulk has a trailer with a base and a wheel, and a towing assembly to connect the trailer to a propulsion means at an attachment location. In a wheel mode, the pulk can rotate around an axis of rotation formed between the bottom of the wheel and the location where the wheeled pulk is attached to the propulsion means. By keeping the center of gravity of the pulk lower than this axis of rotation, the pulk may be more stable and easier to use.

### RELATED APPLICATIONS

This application claims priority from U.S. provisional application 62/852,096 filed on 23 May 2019, which is hereby incorporated by reference in its entirety.

### FIELD

The invention generally relates to travel accessories, and in particular to a wheeled pulk and associated systems.

### BACKGROUND

Expedition travel is popular in summer and winter climates. This travel necessitates hauling gear over large distances and in certain cases over variable terrain.

Summer expedition travel over dry ground may be accomplished with a two-wheeled or single-wheeled cart. When a cart is pulled by a human, a harness may connect to the cart by straps that hang from the shoulders of the user, or a waist harness may connect to the cart by rigid bars.

A shortcoming of the two-wheeled cart is that the wheels must be spaced far enough apart to provide stability, but in many cases, the trail is single-track (less than shoulder width), so the wheels are forced to ride up on the uneven ground on either side of the trail. This is damaging to the environment as well as difficult to pull. Another shortcoming of the two-wheeled cart is that obstacles, such as large rocks, cannot be avoided with both wheels (i.e., two wheels cannot “snake through” obstacles). A further shortcoming of the two-wheeled cart is that it becomes increasingly unstable in “side-hill” terrain (i.e., when contouring around a slope).

A shortcoming of certain known single-wheeled carts is that they are stabilized by the harness or by the bars. This may put an uncomfortable sideways pull on the user if the load is even slightly off-center. A further shortcoming of certain known single-wheeled carts is that the cart is connected to a user with limited degrees of freedom.

A shortcoming of the rigidly connected waist harness is that the user cannot turn freely. Instead, the user must take small side-steps to turn (at a switch-back in the trail, for example). A shortcoming of the shoulder strap carry method is that the cart can slide into the user when going downhill.

Winter expedition travel over snow and ice may be accomplished, for example, with a sled (a.k.a. pulk), typically pulled with poles (draw bars) or a rope connecting the sled to the user through a waist belt or a combination waist belt/shoulder harness.

A shortcoming of using a pulk is that if rocky terrain (i.e. free of ice or snow) is encountered, dragging the pulk may require excessive effort and lead to severe damage of the pulk base. A second shortcoming of the typical pulk is that on uneven terrain the pulk may tip over, slide sideways, and/or be difficult to control. A shortcoming of using ropes for pulling a pulk is that the pulk may slide into the user or past the user when going downhill. A shortcoming of using two poles for pulling a pulk is that the poles often don't prevent tipping, and if the load does tip it can twist and snap the poles.

Certain systems relating to two-wheeled hiking trailers include: Bristol U.S. Pat. No. 8,893,937; Harbeke US 2016/0272233; Phol U.S. Pat. No. 3,856,191; Lemon U.S. Pat. No. 4,236,723; Capraro U.S. Pat. No. 5,215,318; and Cordova U.S. Pat. No. 5,769,431.

Certain systems relating to rollered hiking trailers include: Douglas U.S. Pat. No. 4,838,565.

Certain systems relating to pulks with double poles to a harness include: Richards U.S. Pat. No. 5,653,455; Seekins U.S. Pat. No. 5,090,714; and Silliman U.S. Pat. No. 7,422,223.

Certain systems relating to single-wheeled hiking trailers with pitch but no yaw or roll (i.e., trailer can undulate up and down but not turn or twist) due to horizontally pinned waist belt connections or handles, include: Girard US 2007/0290460; Parker U.S. Pat. No. 7,322,584; Satorius U.S. Pat. No. 7,484,737; Strand U.S. Pat. No. 3,550,997; Giovannoni U.S. Pat. No. 2,613,953; McCoy U.S. Pat. No. 4,664,395.

Certain systems relating to single-wheeled hiking trailers with pitch and yaw but no roll include Hoffman U.S. Pat. No. 5,385,355. U.S. Pat. No. 5,385,355 discloses a monowheel travois which employs an attachment between the backpack and the load carrying frame that will allow the travois to move side to side (yaw) and up and down (pitch) relative to the user without allowing the travois to roll from an upright position. U.S. Pat. No. 5,385,355 also discloses a monowheel travois which employs a load carrying frame configured so that the center of gravity of the load is below the center of gravity of the travois. The load must also be placed so that it does not interfere with the user's normal stride.

Certain commercial embodiments relating to single-wheeled hiking carts with pitch but no yaw or roll include: Dixon Roller Pack; Monowalker; Carrix; and Packwheel.

There continues to be a need for improvements in travel systems which are addressed by various aspects of the invention described herein.

### SUMMARY

According to a first aspect, there is provided a wheeled pulk comprising:

a trailer comprising a wheel and a base for containing or supporting a load; (e.g. cargo, baggage, hiking supplies etc.); and

a towing assembly (or other attachment means) to connect the trailer to a propulsion means at an attachment location,

wherein, in a wheel mode, the trailer is adapted to engage the ground by the wheel thereby forming an axis of rotation between a bottom of the wheel and the attachment location, and wherein a center of gravity of the wheeled pulk is lower than the axis of rotation.

The wheeled pulk may be considered to be a trailer assembly or a wheeled travois.

In the context of this disclosure, the center of gravity of the wheeled pulk may be considered to be the center of gravity of the wheeled pulk components which can rotate with respect to the propulsion means about the axis of rotation (e.g. those components between the bottom of the wheel and the attachment location).

The towing assembly may comprise a connector or joint at the attachment location which is configured to allow rotation of the trailer with respect to the propulsion means about the axis of rotation. That is, this joint may define one end of the axis of rotation, the other end being defined by the bottom of the wheel (e.g. where the wheel connects with the ground underneath).

The towing assembly may be rigid between the attachment location and the base.

The towing assembly may be connected to the propulsion means by a ball and socket joint that permits three degrees of freedom of rotation of the towing assembly relative to the propulsion means. The three degrees of freedom may be: side to side (yaw) relative to the propulsion means; up and down (pitch) relative to the propulsion means; and rotation about the axis of rotation.

An upper surface of the base may be configured to form the base of a basket to contain a load (e.g. baggage). The upper surface of the base may be configured to be lower than the axis of rotation. This means that a load can be mounted on the upper surface of the base such that the center of mass of the load is also lower than the axis of rotation. Therefore, the center of mass of the pulk and load combined will be lower than the axis of rotation leading to more stability.

When in use in the wheel mode, an upper surface of the base may be configured to be lower than a wheel axis. Using a larger wheel may allow the pulk to better negotiate bumps and obstacles. The wheel may be between 12 and 29 inches in diameter. The wheel may be a spoked wheel. The wheel may have a rubber tire. When in use in the wheel mode, the upper surface of the base may be configured to be less than 1 foot off the ground.

The base may be curved upwards from an axis along the direction of travel. The lateral dimension of the base may be less than 30 inches wide. These features may allow the pulk to rotate about the rotation axis without hitting the ground. The lateral dimension of the base may be greater than 12 inches wide.

When in use in the wheel mode, the wheeled pulk may be configured such that the base is horizontal and/or parallel to the ground. This may be facilitated by adjusting the length of the towing assembly and the angle between the towing assembly and the base. The angle between the towing assembly and the base may be defined as the angle between the base and the gooseneck.

The towing assembly may comprise, or connect to, a harness to attach to the back and shoulders of a person. For the purposes of calculating the center of gravity of the wheeled pulk with respect to the rotation axis, the mass of the harness may not be considered because it is affixed to the propulsion means and not able to rotate about the rotation axis with respect to the propulsion means. Where the wheeled pulk is connected to a harness, this may be considered a wheeled pulk assembly.

The attachment location is positioned adjacent to the upper back of the person. Increasing the height of the attachment location also increases the height of the axis of rotation, and the angle of the axis of rotation with the horizontal. This helps allow the center of gravity of the pulk, and of the pulk and load combined to be positioned below the axis of rotation, thereby allowing a more stable pulk.

The towing assembly may comprise a pole attached at a first end to the base, and at a second end to the attachment location. The pole may be a telescopic pole such that the length of the pole can be changed and then fixed. The pole may be rigid.

The trailer may be attached to the towing assembly via an adjustable headset, wherein the headset is configured to allow the angle between the base and the towing assembly to be adjusted. The headset may be rigidly connected to the base (e.g. at or adjacent to the front of the base). The headset may comprise a channel formed by two walls for receiving a pole of the towing assembly. Each wall may comprise a pivot hole and a series of index holes arranged in a circular arc about the pivot hole. When a pin passes through the pivot holes and the received pole, the pole is fixed at that point (but may be free to rotate). Fixing the pole at two points (e.g. at the pivot and at one of the index positions) prevents rotation of the pole with respect to the headset, thereby fixing the angle between the base and the towing assembly. The angle of rotation of the headset may be about a headset axis which is parallel to the wheel axis about which the wheel turns.

The headset may be configured to allow the angle between the base and the towing assembly to be adjusted to a new angle and then fixed in the new angle.

The headset may be configured to allow the angle between the base and the towing assembly to be adjusted to between 15° and 55°.

The wheel may be adjustable such that the trailer is adapted to engage the ground by base in a pulk mode.

The wheel may be mounted to the base by a rotating lockable hinge, such that the wheel can be raised and lowered with respect to the base by rotating the hinge. The hinge axis about which the hinge rotates may be parallel to the wheel axis.

When in use in the wheel mode, the base may be positioned between the wheel and the propulsion means. That is, the wheel is positioned towards the rear of the pulk behind the base. Moving the wheel to the rear increases the area between the axis of rotation and the ground behind the propulsion means. This helps allow the center of gravity of the pulk, and of the pulk and load combined to be positioned below the axis of rotation, thereby allowing a more stable pulk.

The towing assembly may be between 4 and 8 feet long. This allows the base to be positioned away from the back of the propulsion means (e.g. behind the user's feet) while still being in the horizontal position.

The towing assembly may comprise, or be configured to connect to, a harness for attaching to a person, wherein the harness comprises an extended rigid section configured to distribute the forces across an area of the persons body. The extended rigid section may comprise a spine configured to extend down the user's back. The spine may be between 1 foot and 3 feet long. The extended rigid section may extend laterally across the user's back. The lateral extensions may be between 3 and 18 inches across. The harness may comprise resilient cushioning portions for adapting to the user's body.

The wheeled pulk may comprise a single wheel.

An aspect of the disclosure includes a wheeled pulk including: a trailer or sled, the trailer or sled including: a base; and a wheel. The wheeled pulk may further include a towing assembly to connect the trailer to a propulsion means at an attachment location. The trailer may be adapted to engage the ground by the wheel in a wheel mode or the trailer is adapted to engage the ground by the base in a pulk mode. The center of gravity of the wheeled pulk may be proximal to the ground relative to an axis of rotation formed between the wheel and the attachment location when in the wheel mode.

A further aspect of the disclosure includes a wheeled pulk substantially as described and/or shown in the figures.

The wheeled pulk may be adaptable to transport loads efficiently over mixed terrain of dry ground, snow and/or ice.

The wheeled pulk may be configured to haul loads over snow and ice, or configured to carry loads over dry ground.

The towing assembly may be connected to the propulsion means by a ball and socket joint that permits three degrees of freedom of rotation of the towing assembly relative to the propulsion means.

The wheeled pulk may be a monowheel pulk. The pulk may employ an attachment between the harness (e.g. for attaching to a person) and the load carrying frame that will allow the pulk to move side to side (yaw) and up and down (pitch) relative to the user. The pulk may employ a ball-and-socket attachment which deliberately allows the “travois” to roll. I.e. it is not “held” in an upright position but allowed to swing in balance below the “axis of rotation”. By allowing the pulk to roll, the rolling forces will not be transferred to the harness straps or the use, thereby reducing the twisting forces on the user's body.

In addition, when there is a lateral imbalance (i.e., more weight on one side of the base) the freedom to roll allows the load to hang at an angle without imparting a twisting motion on to the user (or other propulsion means).

The pulk may be adjustable in a variety of ways. The pulk may be adjustable in length by extending the portion between the propulsion means and the base. The pulk may be adjustable in angle through the adjustable headset. This allows the center of gravity of the load to be lowered as the length of the pole is adjusted, so the balance conditions for the load can be maintained.

By allowing the load to be moved much further away from the user while maintaining balance with the adjustable headset, the ratio of the load on the wheel to the load on the user can be adjusted. For example, the load can be distributed ⅔ to the wheel and ⅓ to the user.

A pulk or sled may include a low slung carrier used for pulling loads over snow and ice, typically made from a plastic shell.

The propulsion means may be one or more of: a person, an animal (e.g. a horse, dog); and a vehicle (e.g. a tractor, a quad bike, a bicycle).

### BRIEF DESCRIPTION OF THE DRAWINGS

Various objects, features and advantages of the invention will be apparent from the following description of particular embodiments of the invention, as illustrated in the accompanying drawings. Similar reference numerals indicate similar components:

FIG. 1 shows an orthographic view of the headset.

FIG. 2 provides an orthographic view of the headset assembled with its associated parts: the base of the gooseneck, and two quick release skewers.

FIG. 3 is an exploded view of the headset and its associated parts.

FIG. 4 is a side view of the headset in use, showing that the headset has a series of holes, centered about a pivot hole, which allows the gooseneck to be indexed via a quick release skewer, to a specific angle.

FIG. 5 is an alternative side view of the headset in use, showing that, when the index skewer is removed and only the pivot skewer is used, the gooseneck is free to rotate about the pivot.

FIG. 6 shows the assembly in wheel mode.

FIG. 7 shows the assembly in pulk mode.

FIG. 8 shows the assembly in pulk mode, demonstrating the articulation of the headset, while travelling over an undulation in the ground, such as a snow drift.

FIG. 9 shows the axis of rotation and relative position of the center of gravity below the axis.

FIG. 10 is an exploded view of the full assembly.

FIG. 11 is a rear view of the wheeled pulk being towed on a side slope of 15 deg.

FIG. 12 is a diagram of the Harness, showing steps 1-3 of installing the Spine Bar.

FIG. 13 is step 4 of the Spine Bar installation, and also includes detailed views of the Ball Joint and fixturing buckle.

### DETAILED DESCRIPTION

### Introduction and Rationale

The present inventors, having a background in mixed terrain travel systems, realized certain drawbacks in existing systems. For example, there was a lack of suitable solutions for transportation of relatively large (>30 lbs) loads over certain trail conditions, including mixed trail conditions with a slope less than about 20 degrees.

The present disclosure is focused, in part, on winter expedition-style travel, in which loads are heavier or bulkier than can be comfortably carried in a backpack (e.g., multi-day or multi-week arctic expedition). A further focus is on hauling heavy loads over dry terrain (e.g., hauling gear and a large amount of water for a multi-day desert exploration). A further focus is on hauling heavy loads over varying terrain (e.g., transporting game late in the fall when snow may be encountered higher and dry ground lower).

Various aspects of the invention will now be described with reference to the figures. The invention may, however, be embodied in many different forms and should not be construed as limited to the embodiments set forth herein; rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present.

It will be understood that, although the terms “first”, “second”, etc. may be used herein to describe various elements, components, etc., these elements, components, etc. should not be limited by these terms. These terms are only used to distinguish one element, component, etc. from another element, component. Thus, a “first” element, or component discussed below could also be termed a “second” element or component without departing from the teachings of the present invention. In addition, the sequence of operations (or steps) is not limited to the order presented in the claims or figures unless specifically indicated otherwise.

Other than described herein, or unless otherwise expressly specified, all of the numerical ranges, amounts, values and percentages in the specification and attached claims may be read as if prefaced by the word “about” even though the term “about” may not expressly appear with the value, amount, or range. Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Unless otherwise defined, all technical and scientific terms used herein have the same meaning as commonly understood by one of ordinary skill in the art to which this invention belongs.

### Wheeled Pulk

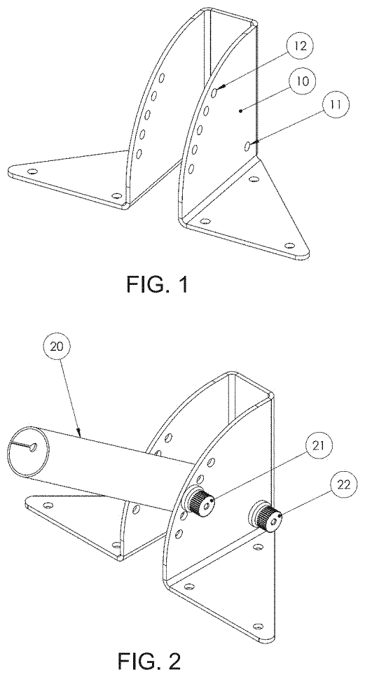

Turning now to FIGS. 1 to 11, there is shown a wheeled pulk and its various components.

In an embodiment, the wheeled pulk consists of a base with a reinforcing frame mounted to it. The frame provides a rigid structure to attach the telescopic “gooseneck” to the front and a retractable wheel to the rear. The frame also assists in minimizing the bending and torsional deflection caused by the load and the forces applied to move the wheeled pulk.

An element of the system is the “headset”, which attaches the gooseneck to the frame. It can either fix the gooseneck in a single position or allow it to float, depending on which mode the wheeled pulk is being used in.

### Mode 1) Wheel Mode

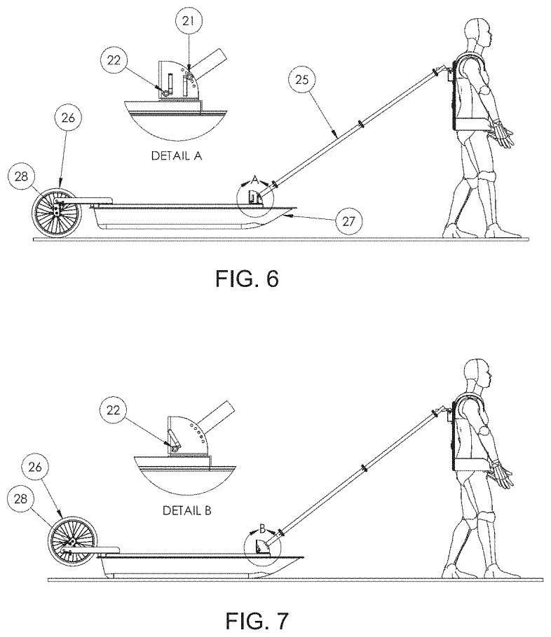

In the wheel mode the wheel is pivoted down and secured in a lowered position, so that it is in contact with the ground. From the pulk mode (described below), two actions are taken to put the wheeled pulk into wheel mode. First, the gooseneck is pinned at two locations in the headset, fixing it to the desired angle. Second, the wheel is locked into the lowered position. The wheel mode is shown in FIG. 6, for example. When the harness is put on by the user, the base is raised off the ground, and the load distribution is split between the user (approx. ⅓) and the rear wheel (approx ⅔). This load distribution significantly reduces user fatigue compared to carrying everything in a backpack. For example, a 100 lb load would only contribute 33 lbs to the user's harness, and the remaining 67 lbs would be carried by the wheel.

### Mode 2) Pulk Mode

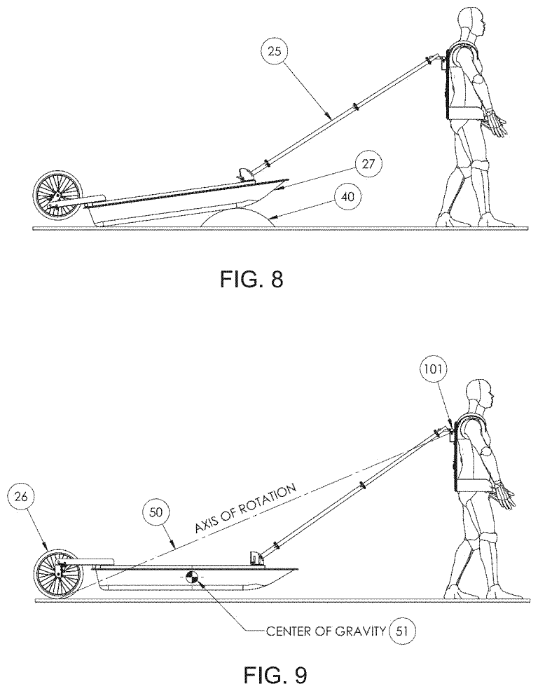

In the pulk mode the wheel is pivoted up and secured in a raised position, so that it is not in contact with the ground. The pulk mode is shown in FIG. 7), for example. This allows the full weight of the trailer and load to rest on the snow/ice. The gooseneck is pinned at only one location in the headset, allowing it to rotate about the pivot point. This allows the base to ride over undulations in the trail (see FIG. 8), for example. That is, in this configuration, the base acts as a sled (e.g. the base is a sled base). An advantage to the pulk mode is that the weight of the load is not directly applied to the shoulder harness.

### Headset and Gooseneck

With reference to FIG. 1), a headset (10) has a Pivot Hole (11), and a series of Index Holes (12) arranged in a circular arc about the Pivot Hole (11), at intervals of approximately 10 degrees. For clarity of the drawings, only one Index Hole (12) is labelled.

With reference to FIG. 2), a Gooseneck Base (20) is installed into the Headset (10), and fixtured in place with two quick release skewers, namely, the Index Skewer (21) and the Pivot Skewer (22).

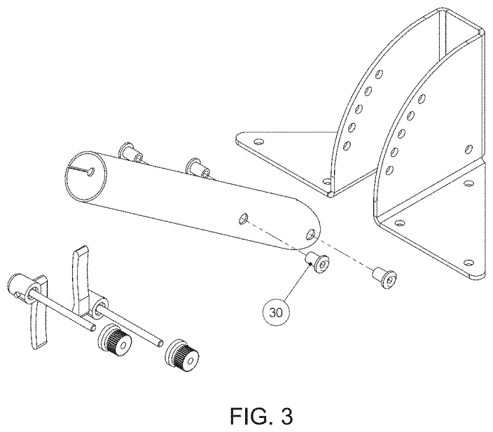

Examining the exploded view FIG. 3), Bronze Bushings (30) can be seen. Only one Bronze Bushing (30) is labelled. The Bronze Bushings (30) are preferably installed into the Gooseneck Base (20) with a press fit. Alternatively, they can be fixtured with an adhesive compound.

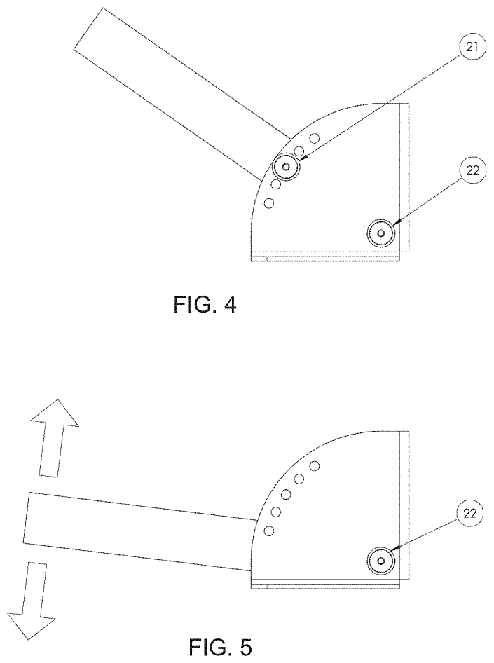

With reference to FIG. 4), if both the Index Skewer (21) and the Pivot Skewer (22) are installed, then the Gooseneck Base (20) is fixed.

Looking now at FIG. 5), if the Index Skewer (21) is removed, then the Gooseneck Base (20) is free to rotate about the Pivot Skewer (22).

Examining FIGS. 6) & 7), the reason for installing or removing the Index Skewer (21) will be demonstrated.

In FIG. 6), and as can be more clearly seen in Detail A, the Index Skewer (21) is installed, fixing the telescopic towing assembly or Gooseneck (25) rigidly at a defined angle. Being rigidly constrained, the front of the Trailer (27) is held up off the ground, with the only ground contact of the trailer being the Rear Wheel (26). In this “wheel mode”, the Rear Wheel (26) is held in place by a Lockable Hinge (28).

Proceeding to FIG. 7), the Index Skewer (21) is removed, leaving only the Pivot Skewer (22) in place. At the same time, the Rear Wheel (26) is retracted by rotating Lockable Hinge (28) upwards. The transport is now in “pulk mode”, which typically involves pulling it along snow or ice covered ground.

FIG. 8) demonstrates the flexibility of having only the Pivot Skewer (22) installed, as it can be seen how the Trailer (27) can follow the contours of the landscape and ride up and over an Obstruction (40) while the Gooseneck (25) is free to rotate to accommodate this movement.

The headset assists in allowing the carrier to be interchangeable between the pulk mode, where the base slides on the ground, and a wheel mode, where the base is raised off the ground and supported between the harness and the rear wheel.

The gooseneck may be telescopically lengthened or shortened to fit the user and optimize comfort and performance depending on terrain.

The headset/gooseneck system allows the wheeled pulk to be “tuned” to the size of the user, the load and terrain. If the load is too low, swinging will be excessive, so the headset angle should be flattened and perhaps the gooseneck shortened. If the load is tending to hang to one side, the headset angle should be steepened so as to lower the center of gravity of the wheeled pulk. If the load is too close to the user, his/her heels may strike the front of the device, so the gooseneck should be lengthened. For a narrow trail with obstacles, the trailer should be closer to the user for maneuverability and raised for clearance. For travel over easy terrain, the gooseneck should lengthened to reduce the weight on the harness. This “tuning” may be done frequently, and hence it may be advantageous for the headset/gooseneck system to include “quick-release” adjustments to allow manipulation of these components without the use of tools. Such quick-release adjustments may be between the gooseneck and the headset or within the gooseneck itself, for example.

A headset may be fabricated by folding sheet metal such as aluminum alloy 5052-H32. This produces a strong, light weight, corrosion resistant, and low-cost part suitable for mass production.

However, any of a variety of well-known construction techniques and suitable materials could also be employed to build the headset. For example, the headset could be assembled from sections of L-angle steel, injection molded in plastic, assembled from plywood, or built up with laminations of carbon fibre and epoxy resin.

### Axis of Rotation

FIG. 9 shows a representation of the Axis of Rotation (50). This is an imaginary line drawn between the ground contact point of the Rear Wheel (26), and the Ball Joint (101) that connects the Gooseneck (25) and a Harness (106). That is, the ball joint is the attachment location in this case.

When the Center of Gravity (51) is below the Axis of Rotation (50), the wheeled pulk is considered self-righting, as any deflection of the Center of Gravity (51) from its lowest position will develop a righting moment to return the wheeled pulk to a position where the Center of Gravity (51) is at its lowest position. A similar principle can be observed on a sailboat with a weighted keel, where a deflection of the keel weight from its lowest point, causes a moment to develop to right the sailboat.

### Assembly

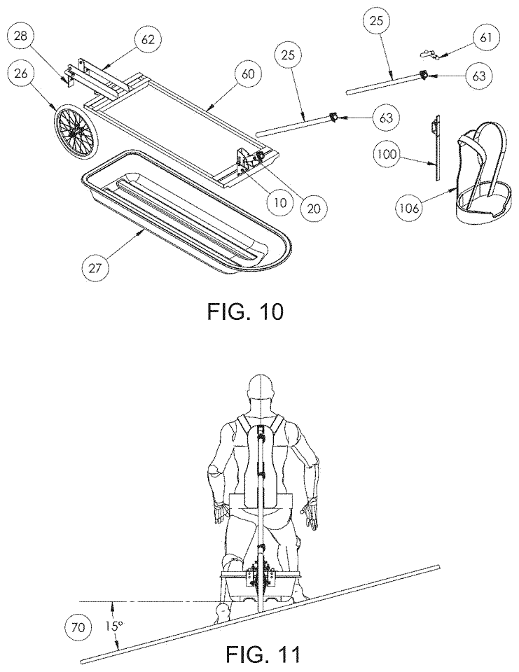

FIG. 10) is an Exploded View of the wheeled pulk, showing a Trailer (27), Reinforcing Frame (60), Fork (62), Lockable Hinge (28), Headset (10) with Gooseneck Base (20), and the mating Telescopic Goosenecks (25), Socket (61), Spine Bar (100), and Harness (106). The Trailer (27) may have a base (which in this case can act as a sled) made of heavy-duty plastic, for example.

In an embodiment, the Reinforcing Frame (60) may be constructed by bolting together square tubing and “L” channel sections, made from high strength, lightweight aluminum alloys. Alternatively, the frame may be welded together, although care should be taken to re-temper the aluminum alloys to achieve the required strength. The Reinforcing Frame (60) may then subsequently bolted to the Trailer (27). The resulting assembly of base and frame may be stiffer and stronger than either of the two items on their own, as they share the applied loads.

The Headset (10) may be mounted to the Reinforcing Frame (60) with standard nuts, bolts, and lock-washers, and the Gooseneck Base (20) may be secured into the Headset (10) as previously described.

The Telescopic Goosenecks (25) each have a Seatpost Clamp (63), which allows tool-free adjustment of the Telescopic Gooseneck (25) length, in much the same way that a typical bicycle seat can be raised or lowered in a bicycle frame.

### Side Slope

FIG. 11) shows how the transport in wheel mode maintains a level travelling position, even on a side slope (such as the 15 degree slope (70) shown in the figure). Having the Center of Gravity (51) of the wheeled pulk be proximal to the ground relative to the Axis of Rotation (50) permits the wheeled pulk to remain level even when the wheeled pulk is on a slope.

### Harness Spine Bar

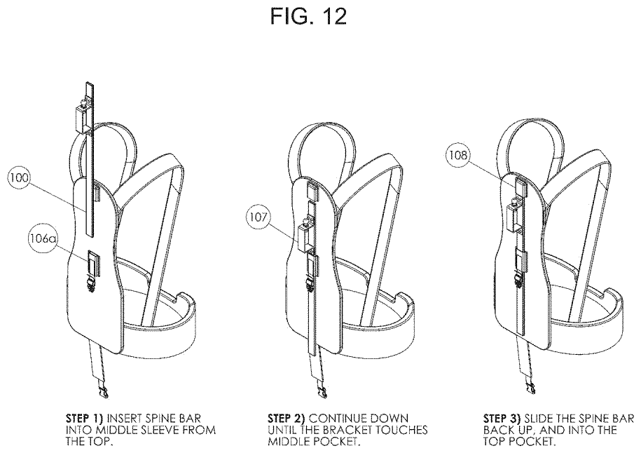

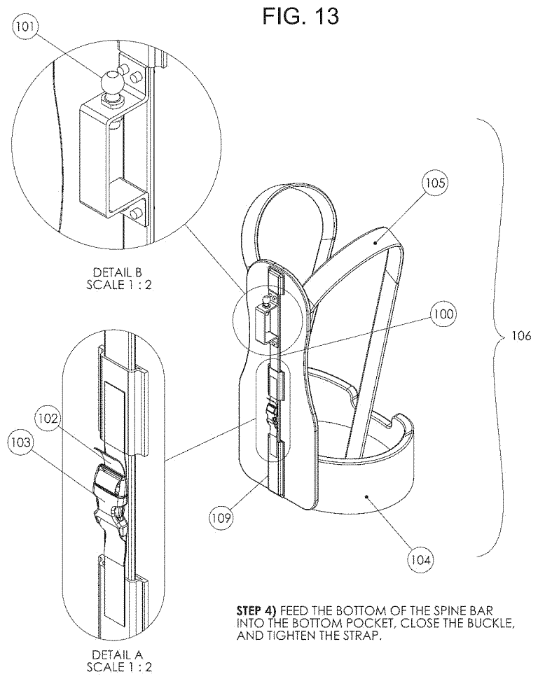

FIGS. 12 & 13 show the assembly steps to install the Spine Bar (100) into the harness (106). FIG. 13 also includes detailed views of the Tightening Strap (102) and Buckle (103), and the Ball Joint (101).

The purpose of the Spine Bar (100) is to provide a location to attach the Ball Joint (101), and a means for communicating the load into the harness, and distributing it between the Hip Belt (104) and Shoulder Straps (105). The spine bar may also be attached to, or part of a rigid back plate which distributes the load across the back. The back plate may be 4″×4″ or greater.

For one skilled in the art, a variety of other ways of attaching the spine bar to the harness could readily be conceived (such as velcro straps or snap buttons). The Spine Bar (100) attachment described herein has been found to be simple, secure, and robust.

The installation steps may include:

Step 1) The Spine Bar (100) is inserted from the top into the Middle Pocket (106a)

Step 2) Lower the Spine Bar (100) down, until the Bracket (107) touches the Middle Pocket (106a).

Step 3) Raise the Spine Bar (100) back up, and into the Top Pocket (108).

Step 4) Feed the bottom of the Spine Bar (100) into the Bottom Pocket (109), close the Buckle (103), and tighten the Strap (102). Tightening the strap ensures that the Spine Bar is snug in the harness, and will not move relative to the harness during changes in the load.

### Ball and Socket

The Ball Joint (101) mates with the Socket (61) that is connected to the Gooseneck (25) and allows pivoting (pitch, yaw, and roll) of the wheeled pulk relative to the user and the harness, so no torque is transferred from the Gooseneck (25) to the user. This type of connection allows three degrees of freedom (DOF) of rotation, and any other connection which similarly allows three degrees of freedom of rotation would permit analogous advantages.

This freedom of movement allows the user to turn to inspect the load, back up easily, and generally move without being restricted by the attachment. For instance, the user may bend forward and backward, twist left and right, or tilt from side to side without affecting the level of the load.

### Features

Elements of the design may include, in certain embodiments, the following features:

The center of gravity of the load and the wheeled pulk is designed to be below the “axis of rotation”, an imaginary line from where the rear wheel contacts the ground to the shoulder connector, and therefore the wheeled pulk is self-righting (stable). The high connection point at the shoulder of the harness may facilitate balancing of the load (like a hammock) below the axis of rotation.

This self-righting behavior allows the wheeled pulk to be completely hands-free during operation, which enables the user to use ski or hiking poles.

The shoulder connector is a ball joint which allows pivoting (pitch, yaw, and roll) of the wheeled pulk relative to the user and the harness, so no torque is transferred to the user. This freedom of movement allows the user to turn to inspect the load, back up easily, and generally move without being restricted by the attachment. It also allows the load to stay vertically in balance when traversing a “side-hill”.

The harness employs both shoulder straps and a hip belt. Even though the ball joint attachment is near the shoulders, the load is distributed via a spine bar between both the shoulders and the hips.

The wheel can be pivoted up and away from ground contact, without needing it to be removed and stowed in the load compartment.

### EQUIVALENTS AND SCOPE

Certain equivalents are also within the scope of disclosure herein. These features include, but are not limited to: brakes, include manual or automatic engagement of the brakes to slow a rear wheel; an electric assist to turn the rear wheel; replaceable runners; anodized aluminum and/or carbon fibre for various components including the frame; forged and machined custom ball and socket to connect to the harness; stabilizing pontoons for water crossing or towing behind a canoe and/or pack raft; fat tire instead of normal bike tire/wheel for the rear wheel; compact foam-filled wheel instead of normal bike tire/wheel for the rear wheel; shock absorber on the rear wheel; viscous damping to reduce swinging/surging of the trailer; bicycle attachment adapter to connect to a bicycle; a version that may fold to reduce space during storage, such as a clamshell version; connections made by tubular welded and heat treated instead of bolted construction; run-away straps; fabric cover, such as a removable cover, which functions as a sleeve or extendable drybag to secure, protect and contain the load and to keep external material from entering the pulk; extendable back and leg supports for use as an emergency transport stretcher; and a detached pulk mode with the use of a hammock or platform slung between the frame rails.

Additional beneficial features may also include that the wheeled pulk may instead or additionally employ plastic runners mounted to the bottom of the trailer which provide enhanced wear protection and improved glide.

As described above, to decrease wear and improve serviceability, replaceable flanged bronze bushings may be installed into the pivot holes in the gooseneck. This may also have the additional benefit of distributing the load more evenly on the quick release skewers.

While this invention has been particularly shown and described with references to embodiments thereof, it will be understood by those skilled in the art that various changes in form and details may be made therein without departing from the scope of the invention encompassed by the appended claims.

### Testing and Prototypes

Embodiments or components disclosed or similar to those disclosed herein have been subject to stress testing, stress modeling, prototyping and/or field testing.

Certain prototypes have included: a steel frame with rigid headset; a carbon fibre tray with rigid headset; a carbon fibre clam shell with rigid headset, ski attachment for wheel, and shock absorber; a wood/foam and/or Kevlar platform with adjustable headset; a wood/aluminum frame and/or Kevlar platform; a plywood/wood frame/Kevlar platform with polyethylene base and P-Tex runners and removable forks/wheel; a frameless pulk base; a framed pulk base with telescopic gooseneck, adjustable headset, retractable wheel, removable back stay.

### Non-Exclusive Fields of Use

The technology could be applied wherever loads need to be transported, for example, by human power. The inventors have speculated at least the following fields of use: through-hikers (e.g., long-distance hikers on the Appalachian Trail); Desert hikers who need to carry all their water; Ageing backpackers who can no longer carry heavy loads; Rock climbers with heavy loads of ropes and climbing gear River rafters who need to portage with inflatable or collapsible boats and gear; Multimodal transport such as using with a bicycle to reach a distant backcountry hiking trailhead; Hunters who need to pack-out game; Trail maintenance crews who need to carry heavy equipment such as chain saws and shovels; Surveyors, geologists or seismic workers carrying heavy instruments or samples; forest firefighters carrying tools, saws and protective equipment, or who need to evacuate a person; search and rescue personnel carrying medical equipment and shelter, or who need to evacuate a person; military personnel who need to carry heavy gear and supplies, or who need to evacuate a person; subsistence families who need to carry water, food or fuel, but cannot afford a beast of burden or motorized vehicle; assisting parents with transporting backcountry family supplies; alternative urban transportation to enhance neighbourhood walkability with less reliance on motorized means of transport.

1. A wheeled pulk comprising:
a trailer comprising a wheel and a base for containing or supporting a load; and
a towing assembly to connect the trailer to a propulsion means at an attachment location,
wherein, in a wheel mode, the trailer is adapted to engage the ground by the wheel thereby forming an axis of rotation between a bottom of the wheel and the attachment location, and wherein a center of gravity of the wheeled pulk is lower than the axis of rotation.

2. The wheeled pulk as claimed in claim 1, wherein the towing assembly comprises a joint at the attachment location which is configured to allow rotation of the trailer with respect to the propulsion means about the axis of rotation.

3. The wheeled pulk as claimed in claim 2, wherein the joint is a ball and socket joint that permits three degrees of freedom of rotation of the towing assembly relative to the propulsion means.

4. The wheeled pulk as claimed in claim 1, wherein an upper surface of the base is configured to form a basket to contain a load.

5. The wheeled pulk as claimed in claim 1, wherein, in use in the wheel mode, an upper surface of the base is configured to be lower than the axis of rotation.

6. The wheeled pulk as claimed in claim 1, wherein, in use in the wheel mode, an upper surface of the base is configured to be lower than a wheel axis.

7. The wheeled pulk as claimed in claim 1, wherein, in use in the wheel mode, the wheeled pulk is configured such that the base is horizontal.

8. The wheeled pulk as claimed in claim 1, wherein the towing assembly comprises a harness to attach to the back and shoulders of a person.

9. The wheeled pulk as claimed in claim 1, wherein the towing assembly comprises a harness to attach to the back and shoulders of a person, and wherein, in use, the attachment location is positioned adjacent to the upper back of the person.

10. The wheeled pulk as claimed in claim 1, wherein the towing assembly comprises a pole attached at a first end to the base, and at a second end to the attachment location.

11. The wheeled pulk as claimed in claim 1, wherein the towing assembly comprises a telescopic pole.

12. The wheeled pulk as claimed in claim 1, wherein the trailer is attached to the towing assembly via an adjustable headset, wherein the headset is configured to allow the angle between the base and the towing assembly to be adjusted.

13. The wheeled pulk as claimed in claim 12, wherein the headset is configured to allow the angle between the base and the towing assembly to be adjusted to a new angle and then fixed in the new angle.

14. The wheeled pulk as claimed in claim 12, wherein the headset is configured to allow the angle between the base and the towing assembly to be adjusted to between 15° and 55°.

15. The wheeled pulk as claimed in claim 1, wherein the wheel is adjustable such that the trailer is adapted to engage the ground by base in a pulk mode.

16. The wheeled pulk as claimed in claim 1, wherein the wheel is mounted to the base by a rotating lockable hinge, such that the wheel can be raised and lowered with respect to the base by rotating the hinge.

17. The wheeled pulk as claimed in claim 1, wherein, in use in the wheel mode, the base is positioned between the wheel and the propulsion means.

18. The wheeled pulk as claimed in claim 1, wherein the towing assembly is between 4 and 8 feet long.

19. The wheeled pulk as claimed in claim 1, wherein the towing assembly comprises a harness for attaching to a person, wherein the harness comprises an extended rigid section configured to distribute the forces across an area of the persons body.

20. The wheeled pulk as claimed in claim 1, wherein the towing assembly comprises a harness for attaching to a person, wherein the harness comprises a rigid spine section configured to distribute the forces down the back of the user.
